(19) United States
(12) Patent Application Publication
(10) Pub. No.: US 2011/0289469 A1
(43) Pub. Date: Nov. 24, 2011

(54) VIRTUAL INTERCONNECTION METHOD AND APPARATUS

(76) Inventors: Thomas B. Huang, San Jose, CA (US); Chioumin M. Chang, San Jose, CA (US); Huan-Chih Tsai, San Jose, CA (US); Ting-Mao Chang, Hsinchu City (TW)

(21) Appl. No.: 12/785,283

(22) Filed: May 21, 2010

(51) Int. Cl. G06F 17/50

(52) U.S. Cl. 716/125; 716/126; 716/137

(57) ABSTRACT

A prototyping system includes (i) a vector processor having an interface for communicating with a host processor and a second interface (e.g., a vector processor bus) for dispatching vectors; (ii) a number of programmable logic circuits each coupled to the second interface to receive the dispatched vectors; and (iii) a compiler for (a) partitioning an electronic circuit into multiple partitions, assigning each partition to one of the programmable logic circuits, (b) providing multiple connections each provided for connecting signals among the partitions, (c) providing in each programmable logic circuit an interface circuit module that manages the connections among partitions using a virtual interconnection technique, and (d) assigning the physical interconnection resources, such as pins of the programmable logic circuits and physical wires on the boards. First and further assigns at least one virtual interconnection (secondary I/O) between partitions to realize the connections among partitions. The prototyping system is associated with a method for prototyping an electronic design, which includes (i) compiling an electronic design into (a) multiple partitions, each partition being compiled for implementation in a programmable logic circuit (e.g., a field programmable gate array integrated circuit), and (b) multiple connections that connect signals between the partition; and (ii) compiling into each programmable logic circuit an interface circuit module for managing the connections using a virtual interconnection technique.

### BACKGROUND OF THE INVENTION

1. Field of the Invention

The present invention relates to electronic design automation tools. In particular, the present invention relates to verification and validation of an electronic design using a prototyping system including programmable logic devices.

2. Discussion of the Related Art

Verification and validation of an electronic design (i.e., design of an electronic circuit) may be accomplished, for example, by compiling, implementing and emulating the electronic design in a programmable logic circuit-based emulation system. Field programmable gate array (FPGA) circuits are often used to implement such emulation system. In an emulation system, the electronic design is typically implemented as a functionally equivalent logic circuit using the combinational and sequential circuit elements and the programmable interconnect and routing resources provided by the programmable logic circuits. The emulation system provides support for injecting input vectors and for examining the values of state and output variables of the electronic circuit, so that correct functional operations of the electronic circuit may be verified. Because the electronic circuit emulation is carried out in hardware, verification of correct functional operations may be achieved much quicker than, for example, using a circuit simulator executing on an engineering workstation. Therefore, such an emulation system is sometimes also known as a “hardware accelerator”.

FIG. 1 shows an exemplary configuration of conventional FPGA-based hardware accelerator 100. As shown in FIG. 1, hardware accelerator 100 communicates over host interface 102 (e.g., a PCI bus) with a workstation 101. Workstation 101 may be a conventional engineering workstation for electronic design having, for example, appropriate simulation capabilities (e.g., behavior, logic and circuit simulators) and work bench capabilities (e.g., test vector generators). With such capabilities, hardware accelerator 100 may receive emulation vectors from workstation 101, or carry out co-simulations or co-emulations with workstation 101. Within hardware accelerator 100, vector processor 103 communicates with workstation 101 via host interface 102. Data, such as emulation vectors, received from workstation 101 are sent to vector dispatcher module 104, which is responsible for routing the data for use in the appropriate portions of the compiled design. Typically, the data is sent to various parts of hardware accelerator 100 via programmable interconnection network 106.

As shown in FIG. 1, programmable interconnection network 106 provides connectivity to the programmable logic circuits (e.g., FPGAs 110, 120 and 130) of hardware accelerator 100. In FIG. 1, connections 111, 121 and 131 represent connections coupled to primary data pins of FPGAs 110, 120 and 130, connections 114, 124 and 134 represent connections coupled to primary clock input pins of FPGAs 110, 120 and 130, connections 116, 126, and 136 represent connections coupled to primary control pins (e.g. bus write or reset) of FPGAs 110, 120 and 130, connections 115, 125 and 135 represent connections coupled to primary probe pins (e.g. user specified internal nodes) of FPGAs 110, 120, 130, and connections 112, 113, 122, 123, 132 and 133 represent connections coupled to interconnection pins of FPGAs 110, 120 and 130. Connections 112, 113, 122, 123, 132 and 133 are not coupled to vector dispatcher 104. (For illustration purpose, the term “primary I/O pin” may be used to refer to any primary pin of an FPGA, including any primary data pin, primary clock input pin, primary control pin, or primary probe pin).

Because a significant number of signals are routed among the FPGAs, vector dispatcher 104 and vector processor 103, the interconnection scheme is complex and renders difficult certain aspects of the verification or validation process (e.g., estimating signal timing). Further, because of the complexity of the interconnection circuits, the time required to compile an electronic design into hardware accelerator 100 is long. In addition, as some FPGAs may reside on other boards with little or very limited physical interconnections among the FPGAs, the compilation process may fail because an acceptable compilation cannot be achieved for a given electronic design.

Recently, numerous advances in emulation system design have been achieved, such as advances that support system-on-a-chip (SOC) design methodology. In one instance, various portions of a SOC integrated circuit may be verified or validated even when other portions of the same integrated circuit are at different stages of development (e.g., by co-emulation). Such an emulation system allows quick implementation (“prototyping”) and incremental verification and validation as each portion of the integrated circuit is developed. One integrated prototyping system is disclosed, for example, in copending U.S. patent application (“Copending patent application”), entitled “Integrated Prototyping System For Validating an Electronic System Design,” Ser. No. 12/110,233, filed on Apr. 25, 2008. The Copending patent application is hereby incorporated by reference in its entirety.

One problem in an FPGA-based system is its low utilization rate of the available FPGAs. The low utilization rate results from the fact that the size of a partition of an electronic design that can be assigned to an FPGA is often limited by the number of pins available in the FPGA to interconnect the assigned partition with other partitions of the electronic design residing in other FPGAs. U.S. Pat. No. 5,761,484, entitled “Virtual Interconnections for Reconfigurable Logic Systems,” filed on Apr. 1, 1994 and issued on Jun. 2, 1998, discloses a method for increasing the utilization rate of an FPGA by multiplexing its interconnection pins in time among signals that are to be received into or transmitted out of the FPGA. The method of the '484 patent, merely shares an interconnection pin among multiple logical interconnections. The method, however, does not take into consideration the circuit being partitioned when assigning the signals to the multiplexed pins. In some applications, it may be desirable to group probe signals, for example, to share physical pins separately from other signals of the partitioned electronic design.

### SUMMARY

According to one embodiment of the present invention, a prototyping system includes (i) a vector processor having an interface for communicating with a host processor and a second interface (e.g., a vector processor bus) for dispatching vectors; (ii) a number of programmable logic circuits each coupled to the second interface to receive the dispatched vectors; and (iii) a compiler for (a) partitioning an electronic circuit into multiple partitions, assigning each partition to one of the programmable logic circuits, (b) providing multiple connections each provided for connecting signals between the partitions, (c) providing in each programmable logic circuit an interface circuit module that manages the connections between partitions using a virtual interconnection technique, and (d) assigning the physical interconnection resources, such as pins of the programmable logic circuits and physical wires on the boards. First and further assigns at least one virtual interconnection (secondary I/O) between partitions to realize the connections between partitions.

According to one embodiment of the present invention, the vector processor is further configured with a router to manage the virtual interconnections between partitions, such that, a secondary I/O signal associated with one partition may be routed through the router to connect to another secondary I/O signal associated with another partition.

According to one embodiment of the present invention, the programmable logic circuits may be provided by FPGA integrated circuits. According to one embodiment of the present invention, the prototyping system may further include a programmable interconnection circuit for interconnecting partitions.

One embodiment of the present invention provides a method for prototyping an electronic design, which includes (i) compiling an electronic design into (a) multiple partitions, each partition being compiled for implementation in a programmable logic circuit (e.g., a field programmable gate array integrated circuit), and (b) multiple connections that connect signals between the partitions; and (ii) compiling into each programmable logic circuit an interface circuit module for managing the connections using a virtual interconnection technique.

According to one embodiment of the present invention, the method further configures a vector processor for communicating control and data signals between the electronic design implemented in the programmable logic circuits and a workstation. The vector processor provides a vector processor bus for interconnecting the interface circuit modules configured in the programmable logic circuits. Each interface circuit links the corresponding partition with the vector processor to manage data traffic to and from the partition over the vector processor bus. The data traffic on the vector processor bus may include both traffic among partitions and traffic between each partition and the workstation. The traffic among partitions on the vector processor bus therefore realizes a virtual interconnection among the partitions.

The present invention is better understood upon consideration of the detailed description below, in conjunction with the accompanying drawings.

### BRIEF DESCRIPTION OF THE DRAWINGS

FIG. 1 shows an exemplary configuration of conventional FPGA-based hardware accelerator 100.

FIG. 2a shows system 200 having a virtual interconnection system, in accordance with one embodiment of the present invention.

FIG. 2b illustrates how virtual interconnection techniques may be implemented, according to one embodiment of the present invention.

FIG. 3 is a flow chart illustrating process 300 for compiling an electronic design into prototyping system 200, according to one embodiment of the present invention.

FIG. 4a is a flow chart illustrating process 400 for mapping logical interconnections to physical interconnection resources of an FPGA and virtual interconnections, in accordance with one embodiment of the present invention.

FIGS. 4b and 4c provide an example that illustrates the operations of process 400.

FIG. 5 shows prototyping system 500 which combines virtual interconnection techniques with a conventional programmable interconnection network, according to another embodiment of the present invention.

### DETAILED DESCRIPTION OF THE PREFERRED EMBODIMENTS

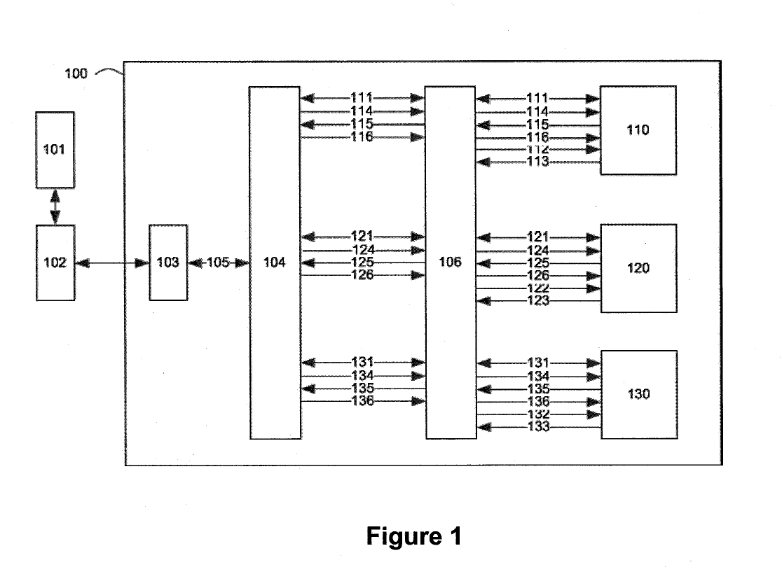

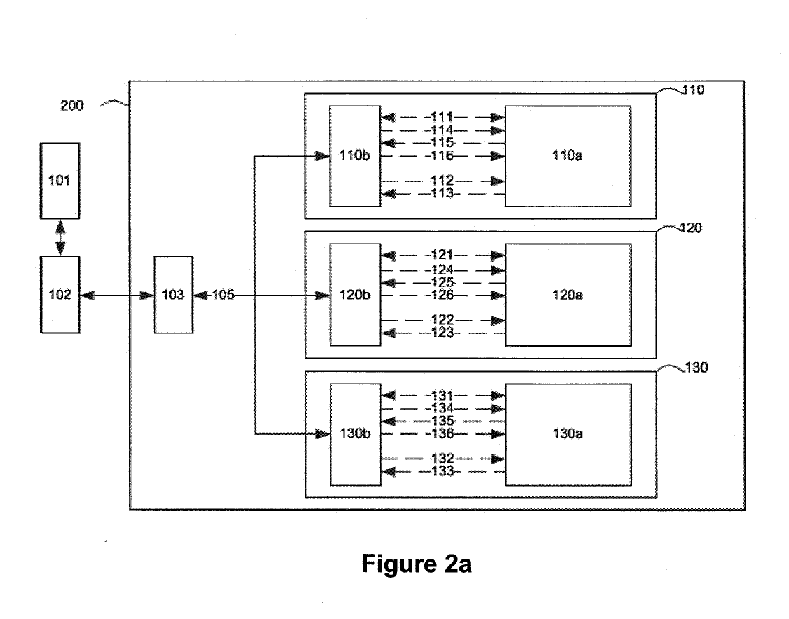

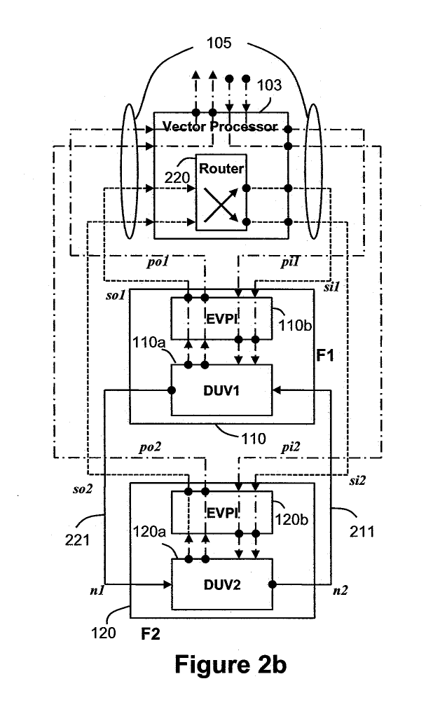

The present invention provides, among other advantages, a prototyping system with simplified interconnection requirements. FIG. 2a shows system 200 having a virtual interconnection system, in accordance with one embodiment of the present invention. In this detailed description, the term “virtual interconnection” refers not only to sharing of an interconnecting resource by more than one signal, it refers also to any technique that routes a signal to its destination without allocating for such a signal exclusive use of a dedicated routing resource. As shown in FIG. 2a, prototyping system 200 communicate over host interface 102 (e.g., a PCI bus) with a workstation 101. Workstation 101 may be, for example, a conventional engineering workstation, such as that described above with respect to FIG. 1. Thus, prototyping system 200 may receive emulation vectors from workstation 101, or carry out a co-simulation or a co-emulation with simulation resources on workstation 101. Within prototyping system 200, vector processor 103 communicates with workstation 101 via host interface 102. Unlike hardware accelerator 100 of FIG. 1, a simplified hardware structure may be provided in prototyping system 200.

As shown in FIG. 2a, vector processor bus (VPB) 105 connects directly to FPGAs 110, 120 and 130, so that data (e.g., emulation vectors) received from workstation 101 may be sent directly to FPGAs 110, 120 and 130 without going through a programmable interconnection network (e.g., programmable interconnection network 106 of FIG. 1), as required in hardware accelerator of FIG. 1. According to the present invention, virtual interconnection techniques (described in further detail below) may be used on VPB 105. In this instance, virtual interconnections are implemented by including in each FPGA an interface circuit module, herein referred to as an embedded vector processor interface (EVPI). For example, as shown in FIG. 2a, FPGAs 110, 120, and 130 include EVPIs 110b, 120b and 130b, respectively, which are provided to handle the interconnections required by DUV partitions 110a, 120a and 130a that are assigned to FPGAs 110, 120 and 130. EVPI 110b, for example, handles the primary I/O signals and the secondary I/O signals of DUV partition 110a for FPGA 110 to vector processor 103, so as to allow further connecting to simulation resources on workstation 101 and to the other DUV partitions, respectively. In FIG. 2a, the primary I/O signals of partition 110a are connected to connection 111, 114, 116 and 115. In FIG. 2a FPGA 110 is also shown the secondary I/O signals of partition 110a being coupled to connections 112 and 113. (Physical connections may also be provided for signals between DUV partitions 110a, 120a and 120a using conventional programmable interconnection techniques; such physical connections are omitted from FIG. 2a for simplicity of presentation).

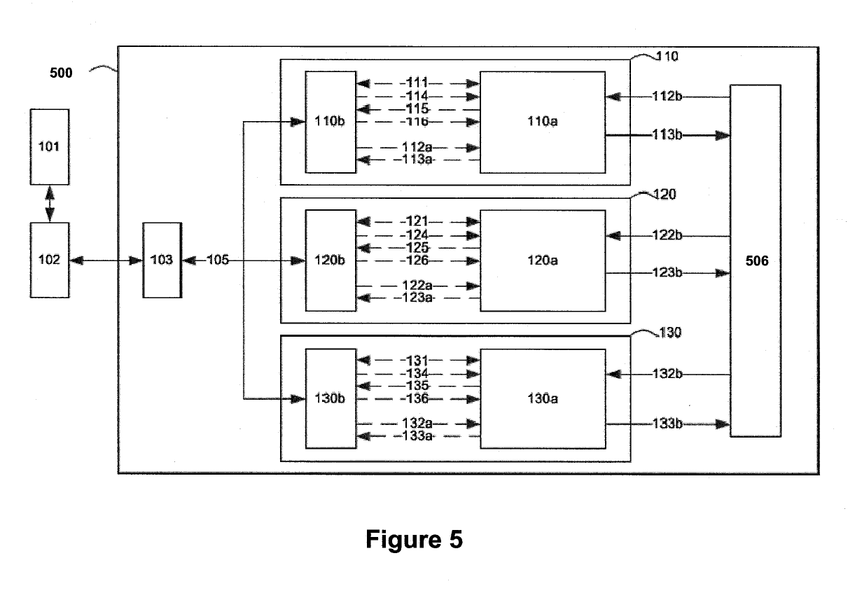

FIG. 2b illustrates how virtual interconnection techniques may be implemented, according to one embodiment of the present invention. FIG. 2b shows virtual interconnections among vector processor 103 and FPGA 110 and 120 of FIG. 2a over VPB 105. To simplify this detailed description, FIG. 2b does not show connections to FPGA 130. However, the principles discussed herein suffice to allow one of ordinary skill in the art to extend the virtual interconnection techniques of the present invention to include any number of FPGAs. FIG. 2b also shows interconnections 211 and 221 between DUV partitions 110a and 120a without using the virtual interconnection techniques. Although such interconnections are not shown in FIG. 2a, such interconnections may be accomplished, for example, using a conventional programmable interconnection technique, or a hybrid technique (i.e., including both virtual interconnection and conventional programmable interconnection techniques), as described further below with respect to FIG. 5.

As shown in FIG. 2b, vector processor 103 implements the connections for both primary I/O signals and secondary I/O signals of partitions 110a and 120a. In this example, vector processor 103 routes (a) the primary I/O signals po1, po2, pi1 and pi2 between host 102 and the FPGAs 110 and 120 and (b) the secondary I/O signals so1, so2, si1 and si2 between FPGAs 110 and 120 through router 220, which is configured in vector processor 103. Router 220 is a virtual interconnection switch providing N input signals and M output signals connectivity. Note that the functional distinction between primary and secondary I/O signals is not necessary in order to implement the virtual interconnection techniques and in fact is provided herein merely for illustrative purpose. Further, instead of the pin-to-pin interconnection approach described above, routing using a network protocol is another approach within the scope of the present invention to implement virtual interconnection techniques. In such an implementation, vector processor 103, EVPI 110b and 120b form a communication network communicating over VPB 105. In yet another embodiment of the present invention, the virtual interconnection system may be implemented by transmitting the signal activities in the form data packets from a source partition to a destination partition, according to a network protocol. The data packet may include one or more IDs for designating its source or destination partition, or both. In such an implementation, vector processor 103 works together with EVPI 110b and 120b to manage the flow of the data traffic on the network. In another embodiment, rather than managing the traffic among EVPIs by vector process 103, each EVPI operates as a network node in its communication with each other.

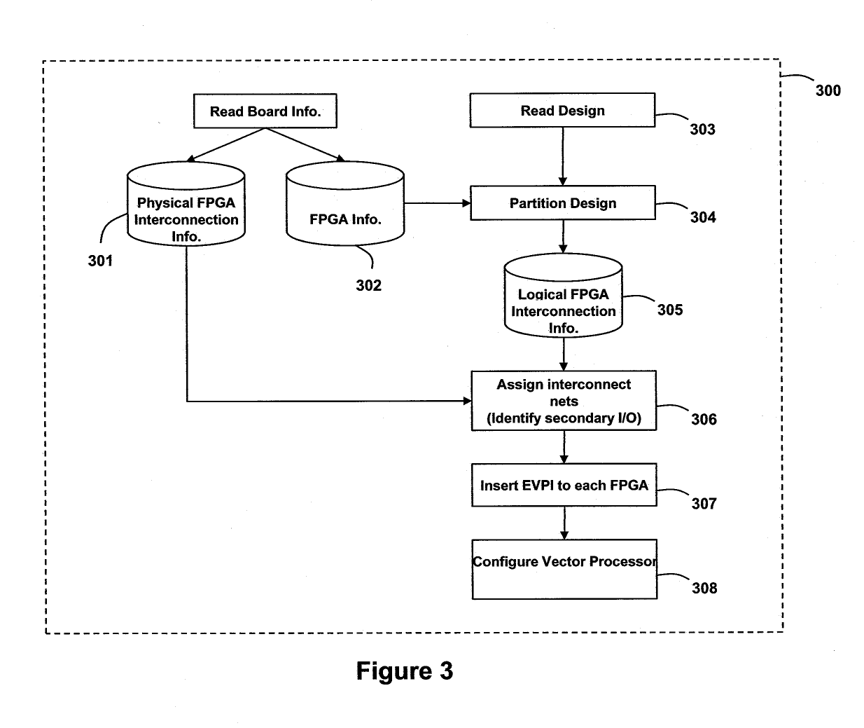

FIG. 3 is a flow chart illustrating process 300 for compiling an electronic design into prototyping system 200, according to one embodiment of the present invention. As shown in FIG. 3, values of the configuration parameters of prototyping system 200, such as physical interconnect resources 301 and FPGA parameter values 302 (e.g., FPGA types and capacities) are stored. At steps 303-304, an electronic design to be implemented in prototyping system 200 (“design under verification” or DUV) is read, synthesized and partitioned by a compiler into multiple partitions suitable for implementation in the FPGAs (e.g., FPGAs 110, 120 and 130) according to the respective capacities of the FPGAs given by FPGA parameter values 302. In one embodiment, the compiler may reside as software on workstation 101. The interconnections (“logical interconnections”) among the partitions, including signals among circuit elements in the DUV and specified probe signals synthesized for the verification, are determined (step 305) and assigned to the physical interconnection resources of FPGAs. The assignment step is guided by physical interconnection resources 301. For the remaining unassigned logical interconnections are assigned to secondary I/O signals (step 306). Mapping of the logic connections to the physical connections may be achieved by, for example, minimizing a cost function. Based on these interconnection assignments, an EVPI (e.g., EVPI 110b, 120b or 130b) may be synthesized, inserted into the FPGA (step 307) and configured to handle the multiplexing of the logic signals onto the physical interconnect resources or retrieval of the multiplexed signals from VPB 105 (i.e., configuring a vector dispatcher). Vector processor 103 is also configured to handle any signal traffic on VPB 105 between the FPGAs and workstation 101 (step 308). During a co-emulation session or a vector emulation session, vector processor 103 may be used to manage scheduling of primary I/O signals and secondary I/O signals. Vector emulation is an electronic design emulation technique disclosed, for example, in copending U.S. patent application, entitled “Method and Apparatus for Debugging an Electronic System Design (ESD) Prototype,” Ser. No. 12/255,606, filed on Oct. 21, 2008. The disclosure of the '606 patent application is hereby incorporated by reference in its entirety.

Thus, using virtual interconnection techniques, FPGA utilization in prototyping system 200 is not limited by the scarce interconnection resources among the FPGAs. Further, the compile time for implementing an electronic circuit in prototyping system 200 for co-emulation and vector emulation is much lessened.

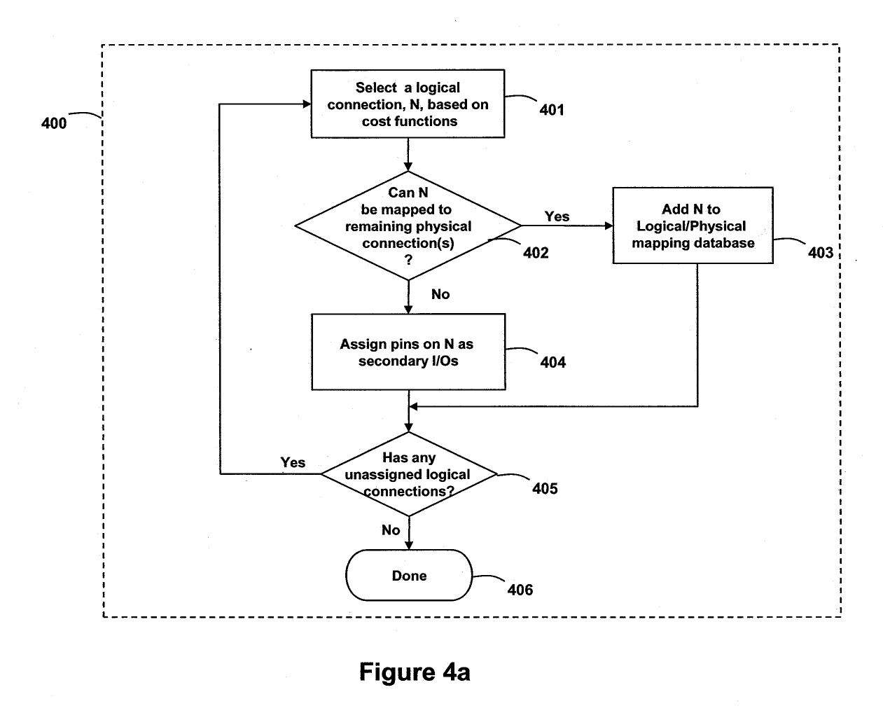

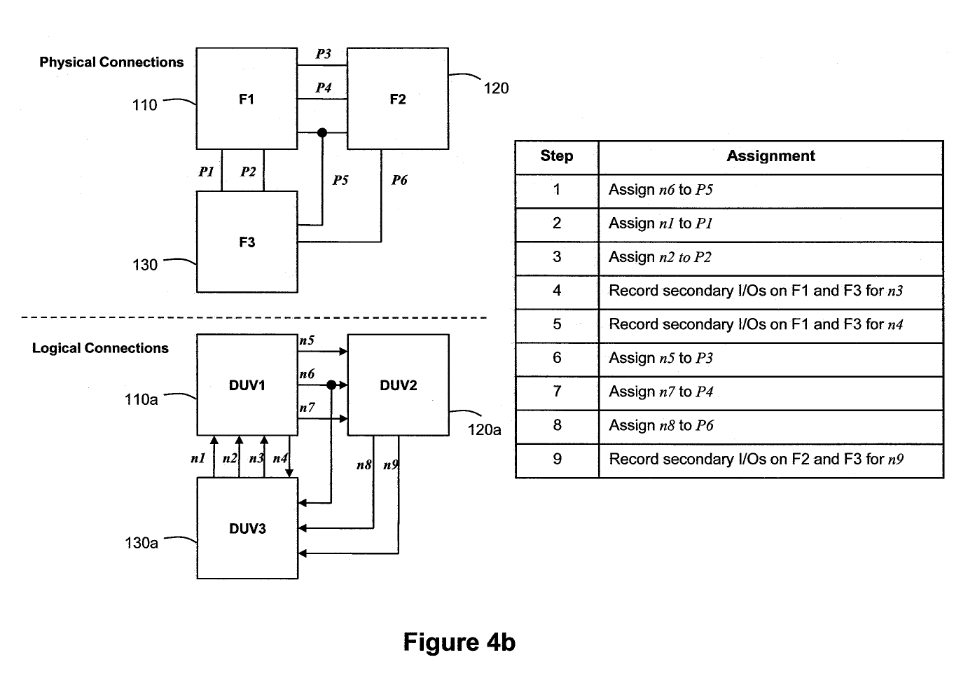

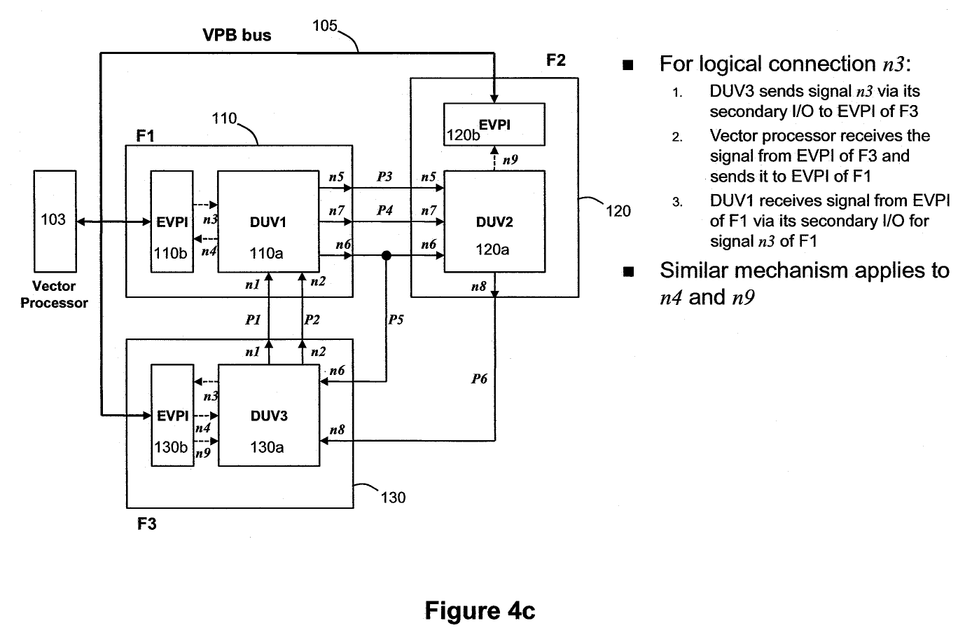

FIG. 4a illustrates process 400 for mapping logical interconnections to physical interconnection resources, in accordance with one embodiment of the present invention. As shown in FIG. 4a, a logical interconnection is selected (step 401, e.g., based on a cost function related to fan-out). In this embodiment, interconnections are selected in a predetermined order one at a time (e.g., in decreasing order of fan-out) and assigned first to available physical nets (step 403). When the physical nets are exhausted, the selected logical interconnections are assigned to secondary I/Os (step 404). Mapping of the logical interconnections to physical interconnection resources continue until all logical interconnections are assigned (step 405).

FIGS. 4b and 4c provide an example that illustrates the operations of process 400. As shown in FIG. 4b, an electronic design is partitioned into DUV partitions 110a, 120b and 130a to be implemented in FPGAs 110, 120 and 130, respectively. For illustrative purpose, FPGAs 110, 120 and 130 are shown to have physical connections P1-P6 among them, and DUV partitions 110a, 120a and 130a are shown to have logical interconnections n1-n9 among them. (Of course, in an actual implementation, the number of physical connections available among FPGAs is much greater, and the number of logical interconnections among DUV partitions is also much greater). According to process 400 of FIG. 4a, the logical interconnections are considered based on their respective cost functions. Therefore, logical interconnection n6 is first considered and is assigned to physical connection P5, according to steps 401-403 of process 400. As each of remaining logical interconnections has only one fan-out, logical interconnection n1 and n2 are assigned to physical connection P1 and P2, respectively.

Logical interconnection n3 is next considered. However, as logical interconnection n3 spans DUV partitions 110a and 130a, logical interconnection n3 cannot be assigned to a physical connection between FPGAs 110 and 130, as both physical connections P1 and P2 are already assigned. Accordingly, step 404 of process 400 assigns logical interconnection n3 to secondary I/O pins of FPGAs 110 and 130, to be implemented as a virtual interconnection by vector processor 103, EPVI 110a and 130a. Likewise, step 404 of process 400 assigns logical interconnections n4 and n9 to secondary I/O signals of FPGAs 110, 120 and 130 to be implemented as virtual interconnections. FIG. 4c shows the resulting physical and virtual interconnections for logical interconnections n1-n9.

As shown in FIG. 4c, logical interconnection n3 is an output signal from DUV partition 130a and an input signal to DUV partition 110a. Accordingly, EVPI 130b sends the signal of logical interconnection n3 to vector processor 103, which routes the signal to EVPI 110b. EVPI 11b then provides the signal to DUV partition 110a. Similar mechanisms are configured for logical interconnections n4 and n9.

FIG. 5 shows prototyping system 500 which combines virtual pin interconnection techniques with conventional programmable interconnection techniques, according to another embodiment of the present invention. As shown in FIG. 5, unlike prototyping system 200 of FIG. 2, a programmable interconnection network 506 is provided in prototyping system 500. In this embodiment, some logical interconnects (connections 112b, 113b, 122b, 123b, 132b and 133b) that would have been assigned to secondary I/Os (connections 112, 113, 122, 123, 132 and 133) in prototyping system 200 are assigned in prototyping system 500 to be routed among FPGAs 110, 120 and 130 via programmable interconnection network 506.

The above detailed description is provided to illustrate the specific embodiments of the present invention and is not intended to be limiting. Numerous variations and modifications within the scope of the present invention are possible. The present invention is set forth in the following claims.

We claim:

1. A prototyping system, comprising:
a vector processor having an first interface for communicating with a host processor and a second interface;
a plurality of programmable logic circuits each coupled to the second interface; and
a compiler for (a) partitioning an electronic circuit into a plurality of partitions each to be assigned to one of the programmable logic circuits, (b) providing a plurality of connections that connect signals between the partitions, and (c) providing in each programmable logic circuit an interface circuit module for managing the interconnections using a virtual interconnection technique.

2. A prototyping system as in claim 1, wherein the programmable logic circuits each comprise a field programmable gate array integrated circuit.

3. A prototype system as in claim 1, wherein the second interface comprises a vector processor bus.

4. A prototyping system as in claim 1, wherein the compiler assigns both physical interconnection resources and virtual interconnection resources.

5. A prototyping system as in claim 4, wherein the virtual interconnection resources interconnect signals among the partitions.

6. A prototyping system as in claim 5, wherein the virtual interconnection resources interconnect secondary I/O signals.

7. A prototyping system as in claim 5, further comprising a router for routing signals among the partitions.

8. A prototyping system as in claim 7, wherein the router and the interface circuit modules implement a network protocol for routing signals among the partitions.

9. A prototyping system as in claim 7, wherein the router is a part of the vector processor.

10. A prototyping system as in claim 4, further comprising, as a physical interconnection resource, a programmable interconnection circuit for interconnecting a selected group, but not all, of the connections.

11. A method for prototyping an electronic design, comprising:
compiling an electronic design into (a) a plurality of partitions, each partition being compiled for implementation in a programmable logic circuit, and (b) a plurality of connections that connect signals between the partition; and
compiling into each programmable logic circuit an interface circuit module for managing the interconnections between partitions using a virtual interconnection technique.

12. A method as in claim 11, wherein the programmable logic circuits each comprise a field programmable gate array integrated circuit.

13. A method as in claim 11, further comprising configuring a vector processor for communicating control and data signals between the electronic design implemented in the programmable logic circuits and a workstation.

14. A method as in claim 13, further comprising providing a vector processor bus between the vector processor and the programmable logic circuits, wherein the interface circuit module manages data traffic in the connections on the vector processor bus.

15. A method as in claim 13, wherein the compiler assigns for interconnecting signals in each partition with the workstation and with the other partitions both physical interconnection resources and virtual interconnection resources.

16. A method as in claim 15, wherein the virtual interconnection resources interconnect signals among the partitions.

17. A method as in claim 16, wherein the virtual interconnection resources interconnect secondary I/O signals.

18. A method as in claim 16, further comprising providing a router for routing signals among the partitions.

19. A method as in claim 18, wherein the router and the interface circuit modules implement a network protocol for routing signals among the partitions.

20. A method as in claim 18, wherein the router is a part of the vector processor.

21. A method as in claim 15, wherein the compiler assigns physical and virtual interconnection resources according to a procedure that minimizes a cost function.

22. A method as in claim 15, further comprising providing, as a physical interconnection resource, a programmable interconnection circuit for interconnecting a selected group, but not all, of the connections.
